(19) United States
(12) Patent Application Publication
(10) Pub. No.: US 2009/0276961 A1
(43) Pub. Date: Nov. 12, 2009

(54) METHOD FOR AROUSING A SLEEPER VIA AUTOMATIC DEFLATION OF AN AIR MATTRESS

(75) Inventors: Jacob Kose, New York, NY (US); Mickey Reiss, New York, NY (US); Artur Meyster, Jackson Heights, NY (US)

Correspondence Address: AMSTER, ROTHSTEIN & EBENSTEIN LLP, 90 PARK AVENUE, NEW YORK, NY, 10016, US

(73) Assignee: ABRAHAM JOSHUA HESCHEL SCHOOL, New York, NY (US)

(21) Appl. No.: 12/116,446

(22) Filed: May 7, 2008

(51) Int. Cl. A47C 27/10; G08B 23/00

(52) U.S. Cl. 5/710; 340/575

(57) ABSTRACT

An embodiment of the present invention is a method for automated deflation of an air mattress to create discomfort and arouse a recumbent individual on the mattress. The method comprises the steps of providing an air mattress comprising a plurality of separate chambers; and automatically deflating at least one chamber of said plurality of separate chambers in response to a signal so as to create discomfort.

### FIELD OF INVENTION

The present invention relates to a method of arousing a recumbent individual by automated deflation of an air mattress leading to the air mattress being converted into a location that is uncomfortable for an individual in repose.

### NO GOVERNMENT LICENSE RIGHTS

No federal government funding was used to develop the present invention. Rather, the present invention was conceived as part of a class project at the Abraham Joshua Heschel School in New York City, N.Y.

### BACKGROUND OF THE INVENTION

Many individuals employ an alarm clock or an alarm radio to arouse them from sleep. It is assumed that the noise of the alarm or radio will be such that the erstwhile sleeper will not be able to go back to sleep. The problem is that an individual who is not motivated to get up can circumvent the arousal system by turning off the alarm or radio. The individual could also choose to simply ignore these devices.

### SUMMARY OF THE INVENTION

According to an embodiment of the present invention, there is provided a method for automated deflation of an air mattress to create discomfort and arouse a recumbent individual on the mattress. The method comprises the steps of providing an air mattress comprising a plurality of separate chambers; and automatically deflating at least one chamber of said plurality of separate chambers in response to a signal so as to create discomfort.

In at least one embodiment, the signal is time-activated.

In at least one embodiment, the automatically deflating step is performed by independently deflating separate chambers of the plurality of chambers in an uneven manner.

In at least one embodiment, the plurality of separate chambers comprises a plurality of separate latitudinal chambers.

In at least one embodiment, the plurality of separate latitudinal chambers comprise six or less latitudinal chambers.

In at least one embodiment, the mattress comprises a head end and a foot end and the latitudinal chambers at the foot end of the mattress deflate before those at the head end.

In at least one embodiment, the plurality of separate chambers comprises a plurality of concentric chambers and the step of automatically deflating at least one chamber comprises deflating a chamber which is located in the center of the mattress.

In at least one embodiment, the step of automatically deflating at least one chamber further comprises deflating the outermost chamber after commencing deflating the chamber which is located in the center of the mattress.

In at least one embodiment, the outermost chamber is not deflated.

In at least one embodiment, the plurality of separate chambers comprises at least three longitudinal chambers and the step of automatically deflating at least one chamber comprises deflating a chamber which is located in the center of the mattress.

In at least one embodiment, one or more protrusions lie on the inside layer of the mattress closest to the floor that arouse the sleeper after the air bed has deflated either fully or partially.

In at least one embodiment, an auditory alarm is set off in response to the signal.

### BRIEF DESCRIPTION OF THE DRAWINGS

The above and related objects, features and advantages of the present invention will be more fully understood by reference to the following, detailed description of an embodiment of the present invention when taken in conjunction with the accompanying figures, wherein:

FIG. 1 is a schematic view of an embodiment of the present invention having an exemplary deflation mechanism;

FIG. 2 is a schematic view of an embodiment of the present invention having an exemplary deflation mechanism;

FIG. 3 is a schematic view of an embodiment of the present invention having latitudinal chambers;

FIG. 4 is a schematic view of an embodiment of the present invention having concentric chambers;

FIG. 5 is a schematic view of an embodiment of the present invention having longitudinal chambers;

FIG. 6 is a schematic view of an embodiment of the present invention containing protrusions on the inside layer of the mattress closest to the floor; and

FIG. 7 is a schematic view of an embodiment of the present invention containing an auditory alarm.

### DETAILED DESCRIPTION OF THE PRESENT INVENTION

The following is a description of various embodiments of the present invention. Although the intention is not to narrowly limit the present invention to the exact specifics described herein but to cover systems that lie within the spirit and scope of the invention.

The present invention relates to a method of arousing a sleeper who is not motivated to get up in response to an alarm system. By removing the sleeper from a sleep advantageous position on an air mattress, the present invention makes it more difficult to remain asleep. It accomplishes this by making an uncomfortable, uneven surface on the air mattress by automatically deflating all or part of the mattress.

According to an embodiment of the present invention, there is provided a system that creates a timed deflation of an air mattress (also known as an “air bed”) that causes an uneven surface. This uneven surface makes lying in a prone position uncomfortable thereby encouraging a sleeper to get out of bed. Since the process of creating this uneven surface is not readily reversible, the individual who is lying in the prone position has the options of either lying in an uncomfortable position or of getting out of bed. The present invention is capable of being completely deflated for ease of storage and thereafter being re-inflated for future use.

In an embodiment of the present invention, an uneven surface is created by deflation of separate chambers within the air mattress. The location of the chambers and the order of deflation are designed to minimize the chance of harm to the sleeper as the air mattress deflates.

Various embodiments of the present invention are hereto described by references to the Figures.

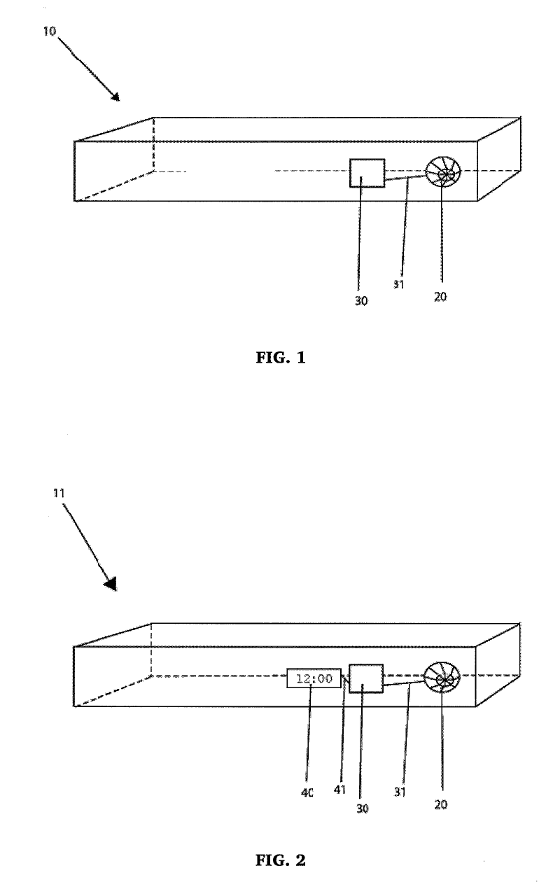

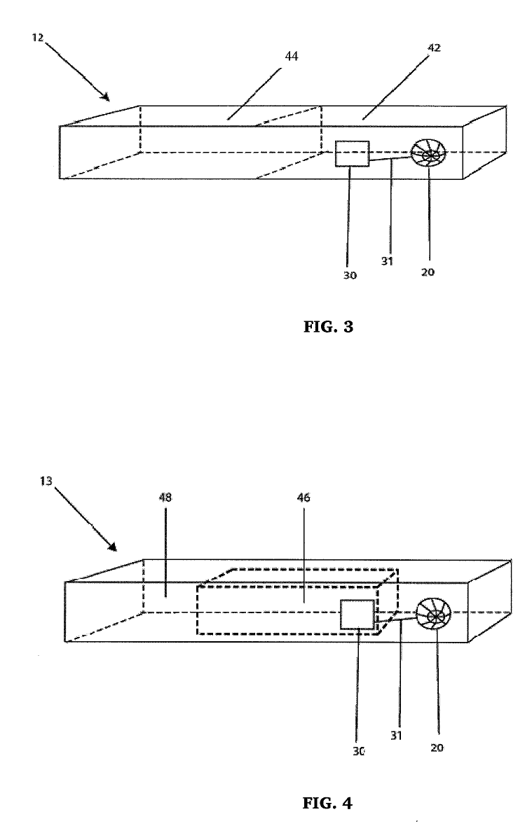

FIGS. 1 and 2 illustrate various exemplary embodiments of automatic deflation trigger mechanisms that can be used in conjunction with the present invention. While a single chamber air mattress is illustrated in FIGS. 1 and 2, this is merely intended to illustrate how the automatic trigger mechanism can be used with the present invention. It is understood that in using the present invention multiple chambers will be used, as illustrated below in the description of FIGS. 3-7, and otherwise described.

FIG. 1 represents an exemplary embodiment of the present invention having a signal control unit. In particular, FIG. 1 is a schematic view of the air mattress (10), comprised of an automated deflation device (20) attached by a wire (31) to a signal-controlling unit (30). When the signal control unit (30) is activated it will send a signal (e.g., an electronic impulse) along wire (31) to activate the automated deflation device (20) and deflate the air mattress (10).

FIG. 2 represents another exemplary embodiment of the present invention having a signal control unit and a time control unit. FIG. 2 is a schematic view of the air mattress (11), comprised of an automated deflation device (20) attached by a wire (31) to a signal-controlling unit (30). The signal-controlling unit (30) is connected by a second wire (41) to a time control unit (40). When an alarm on the time control unit (40) is activated, a signal (e.g., an electronic impulse) is sent along wire (41) to signal control unit (30). Upon receiving the signal, signal control unit (30) will send a signal (e.g., an electronic impulse) along wire (31) to activate the automated deflation device (20) and deflate the air mattress (11). The electronic impulse sent from the signal control unit to the automated deflation device in this embodiment is an example of a “time-activated” signal. Further, the time at which the deflation starts is determined by setting the time control unit. This embodiment may be advantageous for arousing a sleeper in the morning, but can be used for arousing a sleeper at any time of the day.

FIGS. 3-5 illustrate various exemplary embodiments of the exemplary deflation chambers that can be used in accordance with the present invention.

FIG. 3 represents an embodiment of the present invention having latitudinal chambers. FIG. 3 is a schematic view of the air mattress (12) comprised of a plurality of latitudinal chambers (42, 44). Air mattress (12) also comprises an automated deflation device (20) attached by a wire (31) to a signal-controlling unit (30). The signal control unit (30) may be further connected by a second wire (41) to a time control unit (40) as shown in FIG. 2. Although this embodiment shows two latitudinal chambers, it is understood that more such arranged chambers can be used in accordance with the present invention. The number of latitudinal chambers should preferably be six or less. The foot of the bed is known as the “foot end” and the head of the bed is known as the “head end.” Preferably, by deflating the chamber or chambers at the foot end before the head end, an incline is created in which the lower part of the body makes contact with the floor before the head. This minimizes the chances of trauma to the sleeper. As the chamber at the foot end is deflated before the chamber at the head end, the separate chambers are deflated in an uneven manner.

FIG. 4 represents an embodiment of the present invention having concentric chambers. FIG. 4 is a schematic view of the air mattress (13) comprised of an inner chamber (46) and an outer chamber (48). Air mattress (13) also comprises an automated deflation device (20) attached by a wire (31) to a signal-controlling unit (30). The signal control unit (30) may be further connected by a second wire (41) to a time control unit (40) as shown in FIG. 2. Inner chamber (46) and outer chamber (48) may be concentric chambers. Although two concentric chambers are shown, it is understood that more such chambers can be used in accordance with the present invention. Preferably, the inner chamber (46) is automatically deflated causing the central part of the individual's body to initially sink into the center of the mattress. The outer chamber (48) may also be deflated after the inner chamber has commenced deflating.

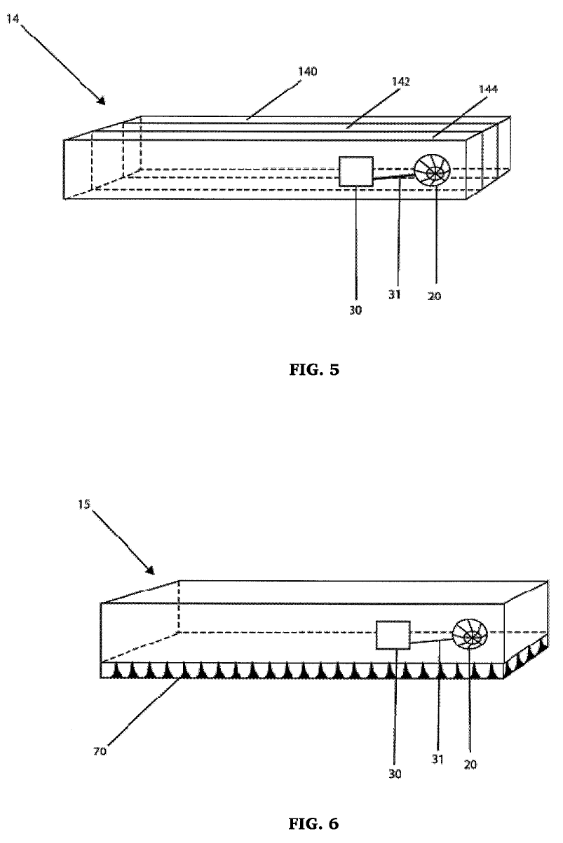

FIG. 5 represents an embodiment of the present invention having longitudinal chambers. FIG. 5 is a schematic view of the air mattress (14) comprised of a plurality of longitudinal chambers (140, 142, 144). Air mattress (14) also comprises an automated deflation device (20) attached by a wire (31) to a signal-controlling unit (30). The signal control unit (30) may be further connected by a second wire (41) to a time control unit (40) as shown in FIG. 2. Although this embodiment shows three longitudinal chambers, it is understood that more such chambers can be used in accordance with the present invention. Preferably, the center longitudinal chamber 142 is automatically deflated thereby causing the individual to sink into the center of the air mattress. This embodiment represents the gentlest form of arousing the sleeper in that it represents the least uncomfortable position for the individual in repose.

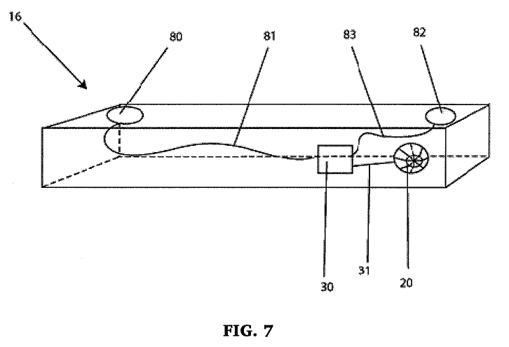

FIG. 6 represents an embodiment of the present invention containing protrusions on the inside layer of the mattress as a further arousal mechanism. FIG. 6 is a schematic view of the air mattress (15) with a plurality of protrusions (70) located on the inside layer of the mattress that is closest to the floor. Air mattress (15) also comprises an automated deflation device (20) attached by a wire (31) to a signal-controlling unit (30). The signal control unit (30) may be further connected by a second wire (41) to a time control unit (40) as shown in FIG. 2. The purpose of the protrusions (70) is to arouse the sleeper after the air bed has at least partially deflated. Even if deflation of one or more of the plurality of chambers of the air mattress is insufficient to create an environment that will arouse the sleeper, the presence of soft protrusions digging into the body should force the individual to arise.

FIG. 7 represents an embodiment of the present invention having an audio alarm device as a further arousal mechanism. FIG. 7 is a schematic view of the air mattress (16), comprised of an automated deflation device (20) attached by a wire (31) to a signal-controlling unit (30). The signal control unit (30) may be further connected by a second wire (41) to a time control unit (40) as shown in FIG. 2. The air mattress (16) includes an audio alarm device comprised of a plurality of audio emitters (80, 82), and an equal number of connecting wires (81, 83) connecting the corresponding audio emitters and the signal-controlling unit. In response to the signal received at the signal controlling until (30), an auditory alarm is set off from audio emitters (80, 82) when the chambers are deflating. The discomfort factor of a deflating air mattress is supplemented by the discomfort of an auditory alarm from audio emitters. This alarm may continue to sound until specifically turned off by the sleeper. The sound from the audio emitters can be timed to occur just prior to the deflation of the air mattress, thus giving the sleeper warning of the impending modification of air mattress.

In each embodiment, the air mattress is capable of being completely deflated for convenient storage, and being re-inflated for future use.

Now that various embodiments of the present invention have been shown and described in detail, various modifications and improvements thereon will become readily apparent to those skilled in the art. The present embodiments are therefore to be considered in all respects as illustrative and not restrictive, the scope of the invention being indicated by the appended claims, and all changes that come within the meaning and range of equivalency of the claims are therefore intended to be embraced therein.

What is claimed:

1. A method for automated deflation of an air mattress to create discomfort and arouse a recumbent individual on the mattress, the method comprising the steps of:
providing an air mattress comprising a plurality of separate chambers; and
automatically deflating at least one chamber of said plurality of separate chambers in response to a signal so as to create discomfort.

2. The method of claim 1 wherein the signal is time-activated.

3. The method of claim 1 wherein the automatically deflating step is performed by independently deflating separate chambers of the plurality of chambers in an uneven manner.

4. The method of claim 1 wherein the plurality of separate chambers comprises a plurality of separate latitudinal chambers.

5. The method of claim 4 wherein the plurality of separate latitudinal chambers comprise six or less latitudinal chambers.

6. The method of claim 4 wherein the mattress comprises a head end and a foot end and the latitudinal chambers at the foot end of the mattress deflate before those at the head end.

7. The method of claim 5 wherein the mattress comprises a head end and a foot end and the latitudinal chambers at the foot end of the mattress deflate before those at the head end.

8. The method of claim 1 wherein the plurality of separate chambers comprises a plurality of concentric chambers and the step of automatically deflating at least one chamber comprises deflating a chamber which is located in the center of the mattress.

9. The method of claim 8 wherein the step of automatically deflating at least one chamber further comprises deflating the outermost chamber after commencing deflating the chamber which is located in the center of the mattress.

10. The method of claim 8 wherein the outermost chamber is not deflated.

11. The method of claim 1 wherein the plurality of separate chambers comprises at least three longitudinal chambers and the step of automatically deflating at least one chamber comprises deflating a chamber which is located in the center of the mattress.

12. The method of claim 1 wherein one or more protrusions lie on the inside layer of the mattress closest to the floor that arouse the sleeper after the air bed has deflated either fully or partially.

13. The method of claim 1 further comprising the step of setting off an auditory alarm in response to the signal.
